(19) United States
(12) Patent Application Publication
(10) Pub. No.: US 2004/0051073 A1
(43) Pub. Date: Mar. 18, 2004

(54) Valve with sealed bellows and packing box for container transporting toxic fluids

(76) Inventor: Christian Estrems, Saint Quentin Fallavier (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/415,987

(22) PCT Filed: Nov. 5, 2001
(86) PCT No.: PCT/FR01/03406

(30) Foreign Application Priority Data
Nov. 7, 2000 (FR) 00/14293

(51) Int. Cl. F16K 31/00

(52) U.S. Cl. 251/335.3

(57) ABSTRACT

The invention concerns a safety valve comprising a body (2) traversed by an actuating rod (1) in translation relative to the body (2), wherein the rod passes through a bellows (3) comprising two metal walls, the bellows being fixed at each of its ends to the body and to the rod, respectively. The invention also concerns a fluid tank whereon is mounted such a valve.

The invention relates to a sealed valve, and more particularly to a sealed valve for a container transporting toxic fluids.

It is known to use a valve in order to isolate the contents of mobile containers from the outside, especially in the field of rail transport. Conventional valves designed for containers transporting toxic fluids, such as HCl or BF₃, are in the form of a body mounted on the containers which provides the join between these containers and external elements. This body comprises a cavity which communicates with an outlet. The valve or the container comprises an inner valve element closing off the entrance to the body, thus providing a first level of sealing of the container against the passage of the fluid. This type of valve comprises an operating stem capable of actuating the inner valve element in order to allow fluid to be removed. Beyond a certain travel, the stem exerts an opening force on the inner safety valve element, thus freeing the passage for the fluid contained in the reservoir toward an external element. A manual device such as a handwheel, or a motorized device such a servomotor or a hydraulic or pneumatic control, makes it possible to move this stem along its axis. The device for operating this stem is placed outside the valve body. The stem therefore extends from the operating device into the valve body.

To ensure the valve body is leaktight where the stem crosses it, stuffing box packing is generally used. This packing usually consists of a stack of PTFE rings surrounding the stem. These rings are compressed along the stem axis, between a stop of the valve body and a stuffing box gland, by means of screws. This axial compression of the rings leads to a radial expansion of these rings. By virtue of this radial expansion, the rings come into contact with the stem, thus sealing the cavity of the body from the outside.

This solution has drawbacks. The valve may have leaks, both during its operation and during transport of the reservoir. While the valve is being operated, the safety valve element is open and therefore allows fluid to pass into the cavity of the body. The stuffing box is then subjected to the fluid pressure, which may reach 200 bar, and must seal the cavity. Now, the stuffing box device has regular leaks inherent to this technology. Those persons responsible for operating the containers, generally containing harmful products, are exposed to these emanations.

In addition, during transport, sealing of the inner safety valve element is imperfect and the stuffing box therefore ensures the valve is leaktight. Mechanical and thermal stresses to which the valve is subject cause random uncontrollable leaks at the stuffing box. Furthermore, leaks of fluids generally stored in a supercritical state generate very high volumes released into the atmosphere.

Since the antipollution standards and the standards for protecting personnel are becoming increasingly strict, these valves require frequent overhauls in order to limit the number of these leaks. Furthermore, vibrations during transport accelerate the deterioration of the stuffing box packing. The container must then be transported, then immobilized for overhaul, which further increases the maintenance costs. Furthermore, the stuffing box packing is more often than not replaced during these overhauls.

The invention provides a solution to these various problems; it provides a sealed join between the stem and the valve body. Leaks of fluid from this join are thus eliminated. It also makes it possible to substantially reduce the maintenance costs associated with maintenance or replacement of the stuffing box packing.

More specifically, the invention relates to a valve comprising a body through which an actuating member able to move relative to the body passes, in which the actuating member passes through a sealed bellows comprising at least two walls, one end of which is secured to the body and the other end of which is secured to the actuating member.

According to another embodiment of the invention, the bellows is made from a corrosion-resistant metal alloy.

According to yet another embodiment of the invention, welds secure the bellows to the body and to the actuating member, respectively. According to a variant, the welds are made with a filler metal around the perimeter of the ends of the bellows. According to another variant, the filler metal comprises a corrosion-resistant metal alloy.

Advantageously, a stuffing box is placed between the body and the actuating member.

According to a preferred embodiment, the body comprises a first body part preferably secured by means of at least one weld to a second body part, one end of the bellows being secured to the first body part.

According to another embodiment of the invention, the actuating member comprises a shaft moving in translation with respect to the body.

According to yet another embodiment of the invention, the valve comprises a valve element closing off a fluid passage, the valve element being actuated by the actuating member. According to a variant, the valve element comprises a spring, a ball and a seat, the spring pressing the ball against the seat.

Advantageously, the bellows is an axisymmetric part. According to a variant, a cross section along a plane passing through an axis of the bellows is substantially sinusoidal. According to another variant, the bellows comprises at least one wall with a thickness greater than 0.2 mm.

The invention also relates to a container comprising a valve according to the invention. According to a particular embodiment, the container contains a toxic fluid; preferably BF₃ or HCl. According to another embodiment, it contains a fluid at a pressure greater than 50 bar, preferably greater than 100 bar.

Other features and advantages of the invention will become apparent on reading the following description of the embodiments of the invention, given by way of example and with reference to the appended drawings, which show:

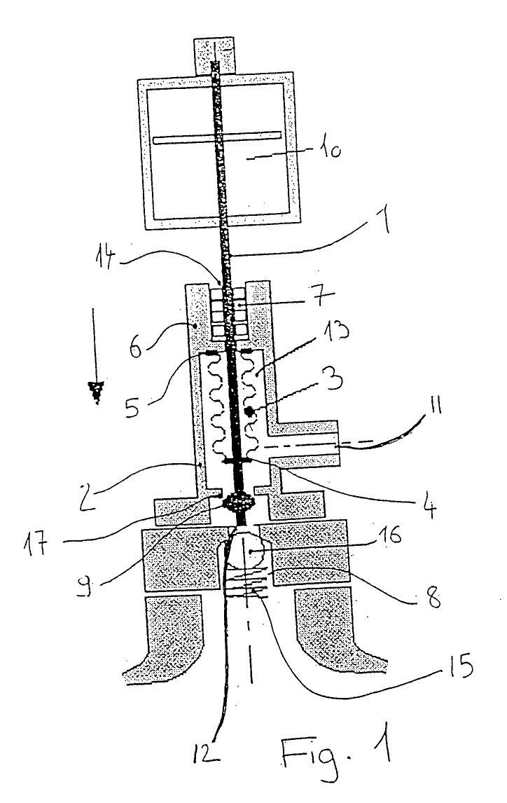

FIG. 1, a schematic sectional view of a valve assembly according to the invention;

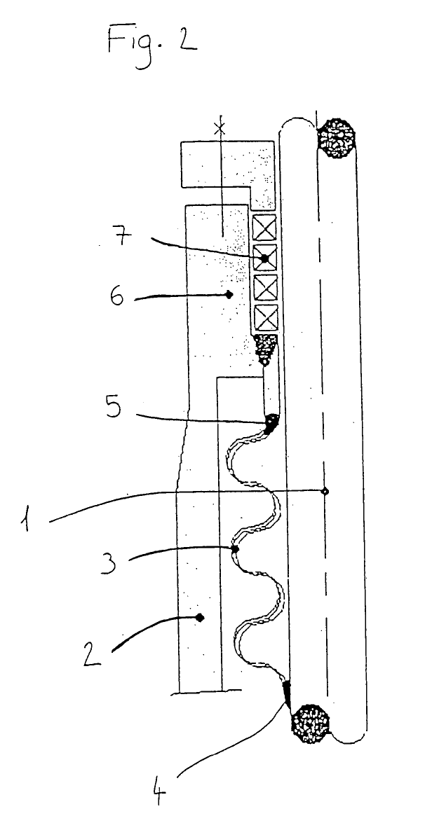

FIG. 2, a detailed sectional view of valve elements according to the invention;

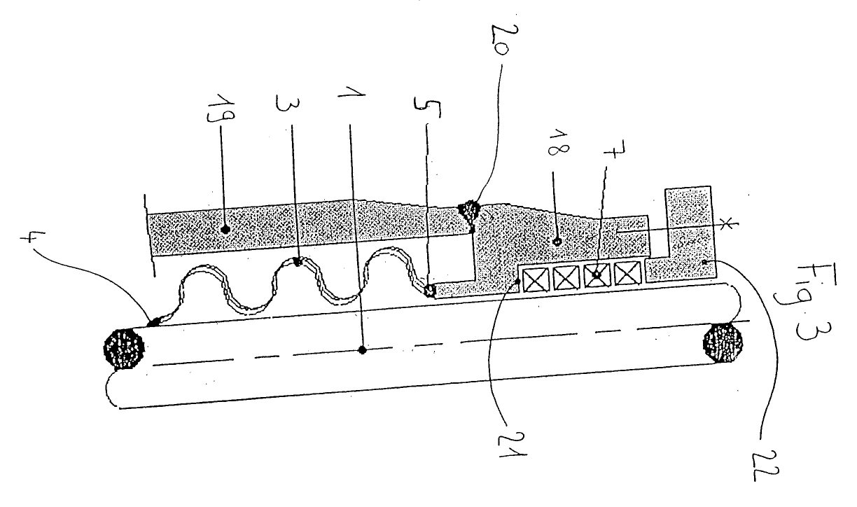

FIG. 3, a sectional view of a particular embodiment of a valve according to the invention.

The invention provides a safety valve for a container, in particular of the mobile type, comprising a bellows, secured both to a valve body and to a valve actuating member, which are movable with respect to each other, said bellows providing a seal between the body and the actuating member. The variable geometry of the bellows makes it possible to move its ends apart, which ends are respectively secured to the body and to the actuating member.

This bellows is sealed in its construction as in its fastenings to the actuating member and to the body, respectively. Thus it ensures that no fluid coming from the container can escape to the outside via a through-passage of the actuating member made in the body.

In this case, a bellows denotes any elements comprising at least one sealed wall surrounding part of the length of a first part which passes through a second part, one perimeter of the wall being fastened in a sealed manner to the first part and another perimeter of the wall being fastened in a sealed manner to the second part around the through-passage of the first part, in which the wall can be deformed in order to match itself to the relative movement of the first part with respect to the second part.

The following example details one embodiment of the valve according to the invention. FIG. 1 is a schematic sectional view of a valve element according to the invention. The figure shows a valve comprising a body 2, in which a cavity 13 is made. An actuating stem 1 passes, from outside the body 2, through a through-passage 14 made in a wall of the body 2 and extends substantially over the entire length of the cavity 13. This stem may be moved translationally along its axis by means of a control device 10, outside the valve body. A flexible bellows 3 is secured in a sealed manner to the stem 1 and to the body 2. This bellows 3 surrounds the actuating stem 1. The actuating stem 1 is thus surrounded between the point at which it is secured to the body and the point at which it is secured to the stem. A pipe 11, made in the body 2, offers communication between the cavity 13 and an outlet of the valve. The cavity 13 of the body communicates with a through-passage 12 made in a part assembled to the valve body. This through-passage 12 is in communication with the container on which the valve is mounted. This through-passage 12 is closed off at rest by a closure member, which preferably comprises an inner safety valve element 8, as in the example of FIG. 1.

The actuating stem 1 comprises an elongate shaft. One of its ends is opposite the safety valve element, at rest closing off the through-passage 12 for the fluid contained in the container. This valve element comprises a spring 15 and a sphere 16. The spring 15 keeps the sphere 16 in position in order to close off the through-passage 12. Thus, when the control device 10 translationally moves the stem in the direction of the arrow shown in FIG. 1, one end of the stem comes into contact with the sphere 16 and moves it. The through-passage 12 is then freed. The fluid contained in the container may then enter the cavity 13 and may be removed by the outlet pipe 11.

Various types of controls 10 may be used to actuate the stem. It is especially known to use manual devices such as a key or a handwheel, or motorized devices such as remotely-actuated servomotors and it is also possible to envision hydraulic, pneumatic or electric controls in order to fulfill this function.

According to a particular embodiment, the actuating member may also comprise a protuberance 9, intended to cooperate with a seat 17 made in the valve body. The protuberance of the actuating member remains in contact with the seat 17 of the body at rest, thus making it possible to provide additional sealing to the valve, at its join with the reservoir.

The bellows 3 is secured by one of its ends to the body 2 close to the through-passage 14. At its other end, the bellows is secured to the stem 1.

As the stem moves, the end of the bellows secured to the body remains fixed, while the other end of the bellows follows the same movement as the stem to which it is secured. The downward movement of the stem (FIG. 1) and consequently of the stem 1, moves the protuberance 9 away from the seat 17 by a few millimeters (for example from 4 to 6 mm). Continuing the movement (for example from 6 to 15 mm) pushes the ball 16 and allows the fluid to pass. The bellows operates in translation by a length increase or decrease corresponding to the movement of the stem. The total travel preferably varies between 8 and 21 mm.

The connections of the bellows with the body and the stem are. Thus the bellows and the body in this case are sealed along a closed outline on the body around the stem by any suitable means, for example by welding or adhesive bonding. Similarly, the bellows extends over the entire circumference of the stem, the bellows and the body are therefore sealed along a closed outline on the stem by suitable means such as welding or adhesive bonding. Thus the cavity of the valve body is sealed from the outside between the connections of the bellows to the body and to the stem.

The bellows shown comprises, for example, at least two leaktight, contiguous, concentric, superimposed walls, with a thickness of several tenths of a millimeter each (for example 0.2 mm), with a minimum internal diameter of 15 mm and a maximum external diameter of 40 mm, made from a nickel-chrome alloy (such as Hastelloy® or Inconel®) or from a nickel-copper alloy (such as Monel®). These features make it possible to ensure a suitable leaktightness at a pressure of 300 bar, over a temperature range of −40 to +50° C. It is also possible to use a bellows comprising several walls, only some of which ensure leaktightness, others more particularly ensuring the mechanical strength of the bellows. This embodiment with multiple walls allows, in particular, the actuating force to be reduced. In fact, for a given thickness of the unit of walls, a bellows with multiple walls has a flexibility greater than a bellows with a single wall. However, it is also advantageous to use a bellows comprising a single wall. In this case, for a given pressure resistance, a wall thickness preferably greater than twice the wall thicknesses used for a double-walled bellows is chosen. Thus the stresses on the bellows are decreased and its life is increased.

The invention implemented with the features described makes it possible to obtain leaks less than 10⁻⁷ Pa.m⁻³.s⁻¹ for a pressure of 200 bar in the container (it is possible to use a helium leak test with the help of a mass spectrometer, for example).

Preferably a cylindrical bellows comprising O-ring bosses or a wavy cylindrical bellows is chosen, as shown in FIG. 1. Such a bellows, whether it has one or more walls, may be made in a known manner by hydroforming. It is also possible to use a frustoconical bellows comprising O-ring bosses. More generally, the bellows may consist of an axisymmetric wall, whose generatrix is a corrugated line. Such shapes make it possible to decrease the axial stiffness of the bellows with respect to a simple cylinder or a regular frustum of the same thickness. Thus, it is possible to deform the bellows elastically by moving the actuating stem. It will be clearly noticed that corrugations along the axis of the bellows decrease the stiffness thereof, since the compressive forces transmitted to the ends of the bellows are applied transversely to the waves thereof.

The bellows is preferably placed inside the cavity of the valve body. However, it is also possible to make a valve according to the invention comprising a bellows outside the body, in particular to make it easier for any leaktightness inspections.

Various particular embodiments of the valve according to the invention are possible, providing additional advantages. Thus it appears to be useful to a person skilled in the art to choose suitable materials forming the bellows which withstand electrochemical corrosion. The bellows will therefore advantageously be made from a material which withstands the corrosion caused by the transported fluid or by the decomposition products generated by the surrounding moisture. The bellows is preferably assembled to the body and to the stem by means of welds 4 and 5 when using a bellows made of metal or of a metal alloy. The welds are preferably made with a filler metal. A weld bead 5 can be made in order to assemble one end of the bellows to the valve body, and a second weld bead 4 can be made in order to assemble the other end of the bellows to the stem. These welds are advantageously able to ensure leaktightness at the join between the body and the bellows on the one hand and at the join between the stem and the bellows on the other hand. To prevent corrosion of the welding zones, it is preferable to use, as filler metal, either the same metal as for the bellows, or an alloy of Cr, Ni, Cu, Mo or Ti.

The body may be made from materials such as carbon steel, stainless steel or from a nickel-based alloy. The stem may be made from a corrosion-resistant material. It may thus be made from a stainless steel or from a nickel alloy.

To make the assembly easier, it is possible to provide a valve body in two parts. FIGS. 2 and 3 illustrate two embodiments of such a body in two parts. The weld made between the bellows and the body may thus be made on a first intermediate part of the body 18, preferably using a material identical or similar to that of the bellows. Thus the body comprises a first part 18, which may if necessary comprise—cf. FIG. 3—a packing box designed to receive a stuffing box packing 7 which will be described below. The first part 18 is welded in a sealed manner to a second part 19 of the valve body. As such, it is possible to manufacture the valve first of all by welding the bellows to the first part of the body, then by welding the bellows to the actuating member and finally by welding the first and second parts 18 and 19 of the body.

It is also possible to use any intermediate part, for example a washer-shaped part, for the stem-bellows connection, in order to make it easier to assemble. Thus it is possible firstly to weld the washer to the bellows, then to weld the washer to the stem.

According to a particular embodiment, shown in FIGS. 1 to 3, it is also possible to have a joint complementing the bellows. Thus, a stuffing box packing 7 may surround the actuating stem at its through-passage 14 into the valve body. Thus it is possible to place the stuffing box packings 7 in abutment against a shoulder 21 placed at the bottom of the box. The packing may then be compressed between the shoulder and a gland 22 which is screwed into the box or into the valve body. The stuffing box packing 7 is thus axially compressed, and therefore extends radially in order to come into contact with the stem. By adding an additional sealing device, the risks of leaks during a highly unlikely failure of the bellows are reduced.

The invention also relates to a reservoir on which a valve as described above is mounted. This reservoir, of cylindrical or spherical shape, generally comprises a bolted opening on which said valve is arranged. The valve may be assembled to the reservoir by any suitable means. It may thus be assembled by screwing onto the aforementioned opening.

Thus it is possible to use such a reservoir in the form of a mobile reservoir for transporting toxic fluids under pressure, especially for the transport of fluids such as BF₃ or HCl.

1. A valve comprising a body (2) through which an actuating member (1) able to move relative to the body (2) passes, in which the actuating member passes through a sealed bellows (3) comprising at least two walls, one end of which is secured to the body and the other end of which is secured to the actuating member.

2. The valve as claimed in claim 1, characterized in that the bellows is made from a corrosion-resistant metal alloy.

3. The valve as claimed in either of claims 1 and 2, characterized in that welds (4, 5) secure the bellows to the body and to the actuating member, respectively.

4. The valve as claimed in claim 3, characterized in that the welds (4, 5) are made with a filler metal around the perimeter of the ends of the bellows.

5. The valve as claimed in claim 4, characterized in that the filler metal comprises a corrosion-resistant metal alloy.

6. The valve as claimed in one of claims 1 to 5, characterized in that a stuffing box (7) is placed between the body and the actuating member.

7. The valve as claimed in one of claims 1 to 6, characterized in that the body comprises a first body part (18) preferably secured by means of at least one weld to a second body part (19), one end of the bellows (3) being secured to the first body part (18).

8. The valve as claimed in one of claims 1 to 7, characterized in that the actuating member comprises a shaft moving in translation with respect to the body.

9. The valve as claimed in one of claims 1 to 8, characterized in that it comprises a valve element (8) closing off a fluid passage (12), the valve element (8) being actuated by the actuating member.

10. The valve as claimed in claim 9, characterized in that the valve element (8) comprises a spring (15), a ball (16) and a seat, the spring pressing the ball against the seat.

11. The valve as claimed in one of claims 1 to 10, characterized in that the bellows is an axisymmetric part.

12. The valve as claimed in one of claims 1 to 11, characterized in that a cross section along a plane passing through an axis of the bellows is substantially sinusoidal.

13. The valve as claimed in one of claims 1 to 12, characterized in that the bellows comprises at least one wall with a thickness greater than 0.2 mm.

14. A container comprising the valve as claimed in any one of the preceding claims.

15. The container as claimed in claim 14, characterized in that it contains a toxic fluid, preferably BF₃ or HCl.

16. The container as claimed in claim 15, characterized in that it contains a fluid at a pressure greater than 50 bar, preferably greater than 100 bar.
